(19) United States
(12) Patent Application Publication
(10) Pub. No.: US 2008/0095111 A1
(43) Pub. Date: Apr. 24, 2008

(54) Method for Hand-Over Between Asynchronous Communication Network and Synchronous Communication Network of Multi Mode Multi Band Mobile Communication Terminal and Mobile Communication Terminal Therefor

(76) Inventors: Young-Lak Kim, Gyeonggi-do (KR); Sung-Ho Shin, Seoul (KR); Jong-Tae Ihm, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 10/594,465

(22) PCT Filed: Mar. 31, 2005
(86) PCT No.: PCT/KR05/00958

§ 371 Date: Aug. 17, 2007

(30) Foreign Application Priority Data
Mar. 31, 2004 (KR) 10-2004-0021964
Apr. 2, 2004 (KR) 10-2004-0022947

(51) Int. Cl. H04Q 7/00

(52) U.S. Cl. 370/331

(57) ABSTRACT

Disclosed are a method for hand-over between an asynchronous communication network and a synchronous communication network of multi mode multi band mobile communication terminal and mobile communication terminal therefor to improve the hand-over connecting rate between an asynchronous communication network and a synchronous communication network in a mixed mobile communication system of an asynchronous network and a synchronous network.

### TECHNICAL FIELD

The present invention relates to a method for hand-over between asynchronous communication network and synchronous communication network or multi mode multi band. More particularly, the present invention relates to a method for hand-over between an asynchronous communication network and a synchronous communication network of multi mode multi band and a mobile communication terminal therefor.

### BACKGROUND ART

As the mobile communication technology develops and the communication network improves, various kinds of mobile communication systems develop, and in order to resolve the problem in global roaming between the mobile communication systems according to the development, IMT-2000 system was developed. The IMT-2000 system is divided into a synchronous system based on CDMA 2000 and an asynchronous system based on WCDMA.

In addition, in order to support the global roaming between mobile communication systems, a mobile communication terminal (Multi Mode Multi Band mobile communication terminal) which can be used in both the synchronous system and the asynchronous system, and by using such mobile communication terminal, each of different service systems can be used in each of the synchronous system area and the asynchronous system area.

Currently, the asynchronous mobile communication system is implemented focusing on the area having great demands for this service. Accordingly, the synchronous mobile communication system is developed to the formation that the service area of the synchronous mobile communication system comprises the service area of the asynchronous system. During such process, if a user reciprocally moves between the asynchronous mobile communication system area and the synchronous mobile communication system area, hand-over between the systems is required in order to provide successive services.

In this regard, since the asynchronous mobile communication system has a communication system, which is different from that of the synchronous mobile communication system, it is quite difficult to embody the hand-over between the systems, and there is a limitation to enhance the probability of success in the hand-over by current hand-over method. In addition, since the multi mode multi band also comprises two modems, it is critical to determine the time of switching on and off the two modems.

If the multi mode multi band mobile communication terminal performs the hand-over in a boundary area of the asynchronous mobile communication system, it takes about 10 seconds for the terminal to trigger the hand-over and to operate the synchronous modem. After operating the synchronous modem, the hand-over often is not performed since the mobile communication terminal moves to the place where the state of the reception signal of the wireless environment is not good.

In addition, at the time of performing the hand-over from the asynchronous mobile communication system to the synchronous mobile communication system, if the synchronous modem of the mobile communication terminal is operated earlier than required, the asynchronous modem and the synchronous modem simultaneously become in the state of on. Thus, there is a disadvantage that the power consumption of the mobile communication terminal increases.

Also, if the hand-over succeeds, an initial power calculating method is required in the mobile communication terminal for the transition to a successful traffic state in the synchronous mobile communication system. However, in terms of attempting the hand-over from the asynchronous mobile communication system to the synchronous communication mobile system, the mobile communication terminal is directly transited to the traffic state while in an idle state of the synchronous mobile communication system without process of the random access. Therefore, the mobile communication terminal performing the hand-over to the synchronous mobile communication system frequently fails in transiting to the traffic state.

### DISCLOSURE OF INVENTION

### Technical Problem

Accordingly, in order to resolve the aforesaid problems, the object of the present invention is to provide a hand-over method between the asynchronous communication network and the synchronous communication network, by operating the synchronous modem of the mobile communication system and maintaining it in a low power mode prior to performing the hand-over from the asynchronous mobile communication system to the synchronous mobile communication system, and according to the performing of the hand-over from the asynchronous mobile communication system to the synchronous mobile communication system by using the low-power state of the multi mode multi band mobile communication terminal which can enhance the probability of success of the hand-over.

In addition, another object of the invention is, at the time of converting to the traffic state in the synchronous mobile communication system of the mobile communication terminal, which performs the hand-over from the asynchronous mobile communication system to the synchronous mobile communication system, to provide a method for setting initial transferring power of the mobile communication system, which performs the hand-over from the asynchronous communication network to the synchronous for determining the initial transferring power value.

### Technical Solution

In order to achieve the above objects, a multi mode multi band mobile communication terminal according to one embodiment of the present invention which can communicate with the asynchronous mobile communication system and the synchronous mobile communication system, and which performs hand-over between the asynchronous mobile communication system and the synchronous mobile communication system, comprising: during communicating with the asynchronous mobile communication system, if conditioned in a predetermined hand-over, an asynchronous modem outputting a modem operating signal for operating a modem to transfer and receive the signal of the synchronous mobile communication system; a synchronous modem operated in an off-state according to the modem operating signal outputted from the asynchronous mobile communication system and then transited to a low power mode, which is a standby mode, wherein said multi mode multi band mobile communication terminal performs the hand-over to the multi mode multi band mobile communication terminal according to the hand-over triggering from the asynchronous mobile communication system by the synchronous modem in the standby mode.

In order to achieve the object, according to another embodiment of the present invention, the hand-over method between the asynchronous communication network and the synchronous communication network of a multi mode multi band which can communicate with the asynchronous mobile communication system and the synchronous mobile communication system, and which comprises an asynchronous modem and a synchronous modem in a mobile communication network where a predetermined size of hand-over cell exists between the asynchronous mobile communication system and the synchronous mobile communication system, comprising: a first step of determining the condition of the hand-over; and, if the hand-over condition is determined in the first step, a second step of operating the synchronous communication network of the mobile communication terminal and transited to a low power mode, which is a standby mode, wherein said the hand-over method performs the hand-over to the synchronous mobile communication system according to the triggering of the hand-over from the asynchronous mobile communication system by the synchronous modem in the standby mode.

In order to achieve the object, the hand-over method between the synchronous communication network and the synchronous communication network of a multi mode multi band, which can communicate with the asynchronous mobile communication system and the synchronous mobile communication system, and which comprises an asynchronous modem and a synchronous modem in a mobile communication network where a predetermined size of hand-over cell exists between the asynchronous mobile communication system and the synchronous mobile communication system according to the other embodiment of the present invention, comprising the step of, when the mobile communication terminal performs the hand-over from the asynchronous mobile communication system to the synchronous mobile communication system, transferring an initial power value received by the asynchronous modem of the mobile communication system from the asynchronous mobile communication system, wherein the synchronous mobile communication system comprises the steps of: receiving a connection requesting signal transferred by an initial transmitting power value of the mobile communication terminal calculated based on the initial power value from the mobile communication terminal and transferring a response to the connection requesting signal to the mobile communication terminal; and transmitting and receiving a traffic between the synchronous mobile communication system and the mobile communication terminal.

### Advantageous Effects

The present invention has an effect of improving the probability of success of the hand-over by, before performing the hand-over from the asynchronous mobile communication system to the synchronous mobile communication system, operating a synchronous modem of the mobile communication system and maintaining it in a low power mode, and by performing the hand-over from the asynchronous mobile communication system to the synchronous mobile communication system.

In addition, at the time of converting to a traffic state in a synchronous mobile communication system of a mobile communication terminal, which performs a hand-over from the asynchronous mobile communication system to the synchronous mobile communication system, the present invention has an effect of providing a method for setting an initial transmitting power of the mobile communication terminal, which performs the hand-over from the asynchronous communication network to the synchronous communication network for determining the initial transmitting power value.

### BRIEF DESCRIPTION OF THE DRAWINGS

FIG. 1 is a block diagram of a mobile communication network applying the present invention;

FIG. 2 is a block diagram of a mobile communication terminal applying the present invention;

FIG. 3 is a flowchart showing a method of hand-over between a synchronous communication network and an asynchronous communication network according to a first embodiment;

FIG. 4 is a flowchart showing a method of hand-over between a synchronous communication network and an asynchronous communication network according to a second embodiment;

FIG. 5 is a view for explaining a state variation of a mobile communication terminal in an asynchronous mobile communication system according to a third embodiment of the present invention; and

FIG. 6 is a flowchart for explaining a method for setting an initial transmitting power of a synchronous mobile communication terminal in an asynchronous communication network according to the third embodiment of the present invention.

### MODE FOR THE INVENTION

In the following description, a mobile communication terminal represents a multi mode multi band mobile communication terminal, which can be used in both of the asynchronous mobile communication system and the synchronous mobile communication system. For example, when the mobile communication terminal enters a hand-over cell area, the synchronous modem is operated, and when a call is sent from the mobile communication terminal or a call is received from the asynchronous mobile communication system, the synchronous modem is operated. The specific explanation thereof will be described later.

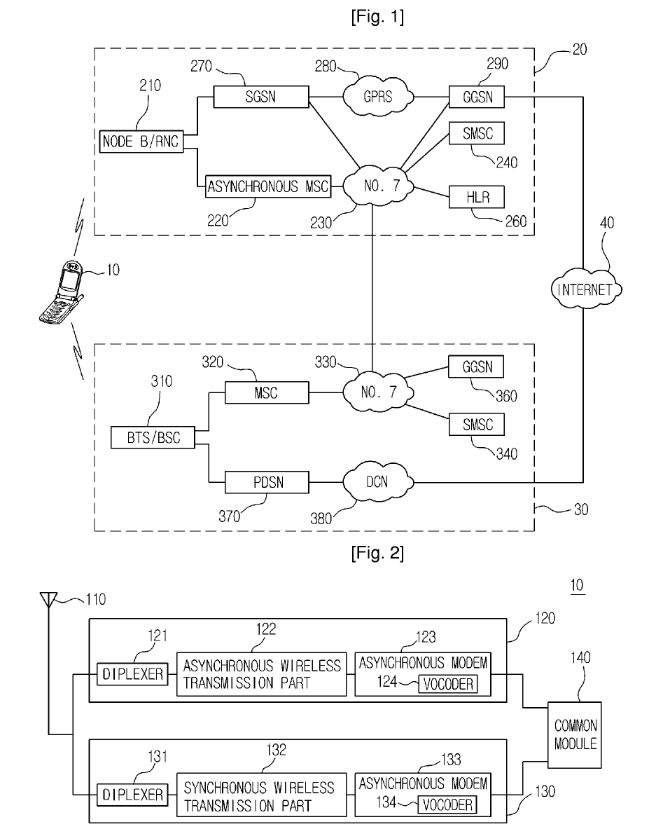

FIG. 1 is a block diagram of a mobile communication network applying the present invention.

A multi mode multi band mobile communication terminal 10 wirelessly accesses to an asynchronous mobile communication system 20 and a synchronous mobile communication system 30, respectively, to use voice and data services.

The asynchronous mobile communication system 20 comprises: node B as a base station for communication with the mobile communication terminal 10 with the radio section communication; a Radio Network Controller 210 (node B/RNC) for controlling node B; a Mobile Switching Center 220 (MSC) connected to the RNC 210 performing a call switching to provide services to the mobile communication terminal 10; a Short Message Service Center 240 (SMSC) connected to the MSC 220 by a No. 7 common signal network 230; a Home Location Register 260 (HLR); a Serving Support Node 270 (SGSN) connected between the RNC 210 and a General Packet Radio Service network 280 to maintain the position track of the mobile communication 10 and to perform the access controlling and the security; and a GGSN 290 (Gateway GPRS Support Node) connected by the SGSN 270 and a GPRS network 280 and connected to the Internet 40 to support the interworking with an external packet.

Also, the synchronous mobile communication system 30 comprises: a Base Transceiver Station (BTS) supporting the radio section communication with the mobile communication terminal 10 and a Base Station Controller 310 (BSC); a Mobile Switching Center 320 (MSC) connected to at least one or more BSCs for performing a call switching; a Short Message Service Center 340 connected to the MSC 320 by the No. 7 common signal network 330; a Home Location Register 360 (HLR); a Packet Data Service Node (PDSN 370) connected to the BSC 310 for providing a packet data service to the subscriber; and a Data Core Network 380 (DCN) for supporting the connection between the PDSN 370 with the Internet 40.

The MSC of the asynchronous mobile communication system 20 and the synchronous mobile communication system 30 are interconnected by the No. 7 common signal network 230, 330 to transmit and receive the information required for the hand-over, etc. of the mobile communication terminal 10. Also, the HLR 260, 360 can be embodied as a dual stack home location register, and it stores and manages subscriber's information, utilization of supplementary services and so on, and provides a subscriber's information according to the request of the MSC 220, 320.

FIG. 2 is a block diagram of a mobile communication terminal applied to the present application.

As shown in the drawings, the multi mode multi band mobile communication terminal 10 applied to the present application comprises: an antenna 110; a module 120 for an asynchronous mobile communication system; a module 130 for a synchronous mobile communication system; and a common module 140.

More specifically, the antenna 110 can simultaneously handle the frequency bandwidth for the synchronous mobile communication service and the frequency bandwidth for the asynchronous mobile communication system.

The asynchronous module 120 comprises: a diplexer 121 for dividing each frequency to process and operate them; an asynchronous wireless transmission part 122 separating the transmitted and received frequency into a predetermined frequency bandwidth; a synchronous modem 123 for processing the asynchronous mobile communication system and the radio section protocol; and a vocoder 134 for performing an encryption and decryption of a signal.

The common module 140 comprises: an application processor operating as a central processing unit for controlling an asynchronous modem 123 and a synchronous modem and performing a multimedia function; a memory; an input and output part; and an application processing part and so on.

Also, the multi mode multi band mobile communication terminal 10 mounts software for managing the user's interface, the supplementary service and the mobility, and the control of the connection/session, the resource and the protocol, so that the user can use various kinds of application services, the hand-over is performed, and the protocol is performed to fit the mobile communication system.

It can be an example of the mobile communication terminal as explained above that when it enters the hand-over cell area, the synchronous modem is operated and when a call is sent from the mobile communication terminal or a call is received from the asynchronous mobile communication system, the synchronous modem is operated.

More detailed explanation will be described later.

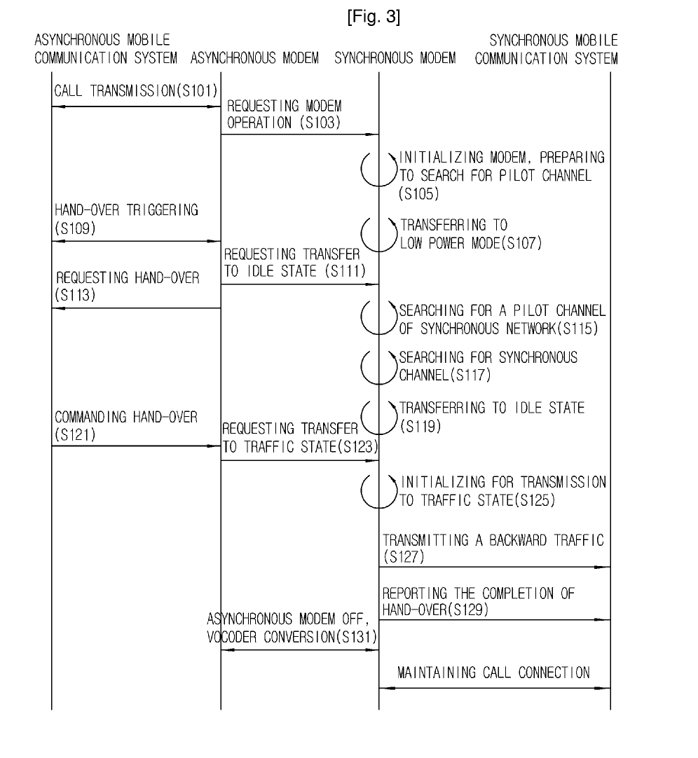

FIG. 3 is a flowchart for showing a method for hand-over between the synchronous communication network and the asynchronous communication network according to the first embodiment of the present invention. As an example, the case of operating the synchronous modem 133 of the mobile communication terminal 10 when a call is transmitted from the multi mode multi band mobile communication terminal located in the asynchronous communication network or a call is received from the asynchronous communication network.

If a call is transmitted from the mobile communication terminal 10 located in the service area of the asynchronous mobile communication system, or a call is received from the synchronous mobile communication system 20 (S101), the asynchronous modem 123 of the mobile communication terminal 10 requests the synchronous modem 133 to be operated (S103).

Accordingly, the synchronous modem 133 of the mobile communication terminal 10 is operated for searching for the initialization process of the modem and the pilot channel of the synchronous mobile communication system 30 to perform the initialization (S105).

After operating the synchronous modem 133 and performing the initialization, the synchronous modem 133 is transferred to a low power mode (S107). At this time, the low power mode of the synchronous modem 133 represents that although the power of the synchronous modem 133 is on, the transmitting and the receiving of information are suspended and the CPU operation of the modem is stopped. The current consumption amount is 1 [symbol] ˜1.5 [symbol] , which is smaller than that of the existing idle state.

Herein, it takes about 1 second for the synchronous modem 133 to transfer from the low power mode to the idle state.

As the mobile communication terminal 10 using the service of the asynchronous mobile communication system 20 moves to the service area of the synchronous mobile communication system 30 through the hand-over cell area, the asynchronous mobile communication system 20 and the synchronous modem 123 perform the trigger for the hand-over (S109).

The asynchronous modem 123 requests the synchronous modem 133 to transfer to the idle state (S111), while requesting the hand-over to the asynchronous mobile communication system (S113). At this time, the asynchronous modem 123 transmits the system information obtained from the base transceiver station of the asynchronous mobile communication system 20.

According to the request to transfer to the idle state in the step S111, the synchronous modem 133 searches the pilot channel and the synchronous channel of the synchronous mobile communication system (S115, S117), and then is transferred to the idle state (S119).

Thereafter, the asynchronous mobile communication system 20 instructs the asynchronous modem 123 to perform the hand-over based on the system information obtained from the base transceiver station of the asynchronous mobile communication system transmitted in the step S113 (S121), the synchronous modem 123 requests the synchronous modem 133 to transfer to a traffic state through the common module 140 (S123).

Accordingly, the synchronous modem 133 performs the initialization for transferring to the traffic state, and transmits a backward traffic to be synchronized with the synchronous mobile communication system 30 (S127).

Then, the synchronous modem 133 reports to the base transceiver station of the synchronous mobile communication system 30 that the hand-over is complete (S129), and then makes the asynchronous modem 123 and the asynchronous vocoder 124 to become off through the common module 140 and operates the synchronous mobile communication system the synchronous vocoder 134 to convert the vocoder.

After performing the hand-over from the asynchronous mobile communication system 20 to the synchronous mobile communication system 30, the synchronous modem 133 of the mobile communication terminal 10 maintains the call connection state prior to the hand-over to be good.

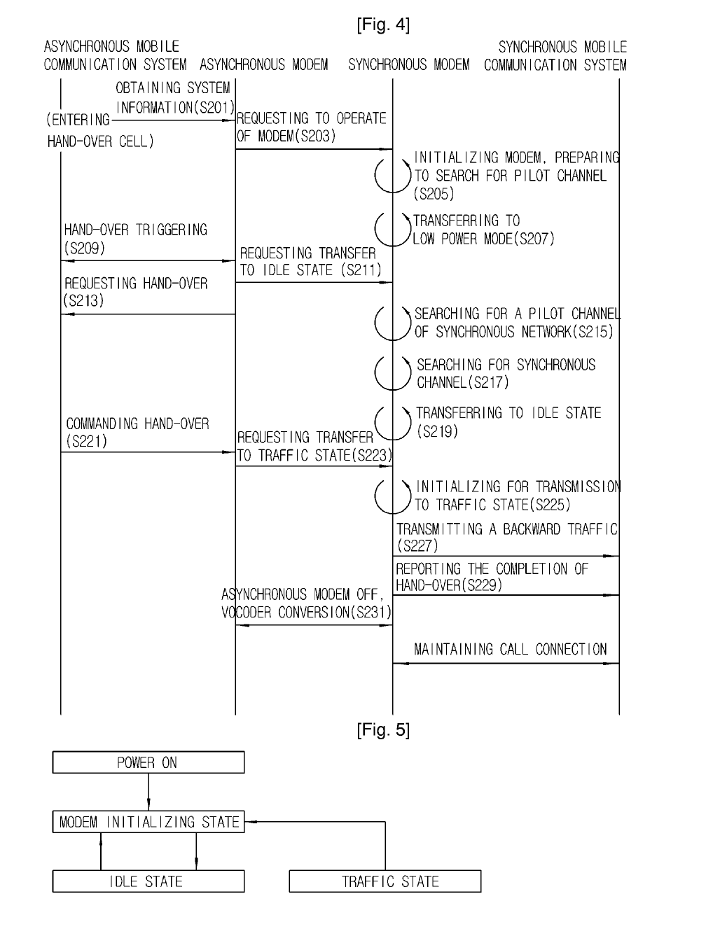

FIG. 4 is a flowchart showing a method for hand-over between the synchronous communication network and the asynchronous communication network according to the second embodiment of the present invention. As an example, it will be explained that if the multi mode multi band mobile communication terminal located in the asynchronous communication network moves to the hand-over cell area, the synchronous modem 133 of the mobile communication terminal 10 is operated.

If the a mobile communication system 10 enters the service area of the synchronous mobile communication system from the asynchronous mobile communication system, the asynchronous modem 123 of the mobile communication terminal 10 obtains system information from the base transceiver station of the synchronous hand-over cell area, and recognizes that the mobile communication terminal 10 enters the hand-over cell area. Accordingly, the asynchronous modem 123 requests the synchronous modem 133 to be operated through the common module 140 (S203).

Herein, if the synchronous modem 123 of the mobile communication terminal 10 enters the hand-over cell area, it automatically requests to operate the synchronous modem 133.

Accordingly, the synchronous modem 133 of the mobile communication terminal 10 is operated to search for the initialization process of the modem and the pilot channel of the synchronous mobile communication system 30 and performs the initialization (S205).

After the synchronous modem 133 is operated and performs the initialization, the synchronous modem 133 is transferred to the low power mode (S207). At this time, the low power mode of the synchronous modem 133 represents that although the power of the synchronous modem 133 is on, the transmitting and receiving of information are suspended and the CPU operation of the modem is stopped. The current consumption amount is 1 [symbol] ˜1.5 [symbol] , which is smaller than that of the existing idle state. Herein, it takes about 1 second for the synchronous modem 133 to transfer from the low power mode to the idle state.

As the mobile communication terminal 10 using the service of the asynchronous mobile communication system 20 moves to the service area of the synchronous mobile communication system 30 through the hand-over cell area, the asynchronous mobile communication system 20 and the synchronous modem 123 perform the trigger for the hand-over (S209).

The asynchronous modem 123 requests the synchronous modem 133 to transfer to the idle state through the common module 140 (S211), while requesting to perform the hand-over to the asynchronous mobile communication system (S211). At this time, the asynchronous modem 123 transmits the system information obtained from the base transceiver station of the asynchronous mobile communication system 20.

According to the request to transfer to the idle state in the step S211, the synchronous modem 133 searches for the pilot channel and the synchronous channel of the synchronous mobile communication system (S215, S217), and then is transferred to the idle state (S219).

Thereafter, the asynchronous mobile communication system 20 instructs the asynchronous modem 213 to perform the hand-over based on the system information obtained from base transceiver station of the asynchronous mobile communication system transmitted in the step S113 (S221), the synchronous modem 123 requests the synchronous modem 133 to a traffic state through the common module 140 (S223).

Accordingly, the synchronous modem 133 performs the initialization for transferring to the traffic state, and transmits a backward traffic to synchronized with of the synchronous mobile communication system 30 (S227).

Then, the synchronous modem 133 reports to the base transceiver station of the synchronous mobile communication system 30 that the hand-over is complete (S229), and then makes the asynchronous modem 123 and the asynchronous vocoder 124 to become off through the common module 140 and operates the synchronous mobile communication system the synchronous vocoder 134 to convert the vocoder (S231).

After the step S231, the synchronous modem 133 maintains the idle state.

FIG. 5 is a view explaining the state variation of the mobile communication terminal in the synchronous mobile communication system according to the third embodiment, showing the process that the mobile communication terminal, which performs the hand-over from the asynchronous mobile communication system to the synchronous mobile communication system, is converted to the traffic state.

As shown in FIG. 5, after performing the hand-over from the asynchronous mobile communication system 20 to the synchronous mobile communication system 30 and converting from the synchronous modem initialization state to the idle state, if the multi mode multi band mobile communication terminal 10 located in the synchronous mobile communication system is converted to the traffic state, it is directly converted to the traffic state without passing the existing system access state.

After performing the hand-over, the reason for converting to the traffic state directly without passing the system access state is that at the time of performing the hand-over from the asynchronous mobile communication system to the synchronous mobile communication system, the search for the pilot channel and the synchronous channel, etc. is performed in advance. More detailed reason will be explained later.

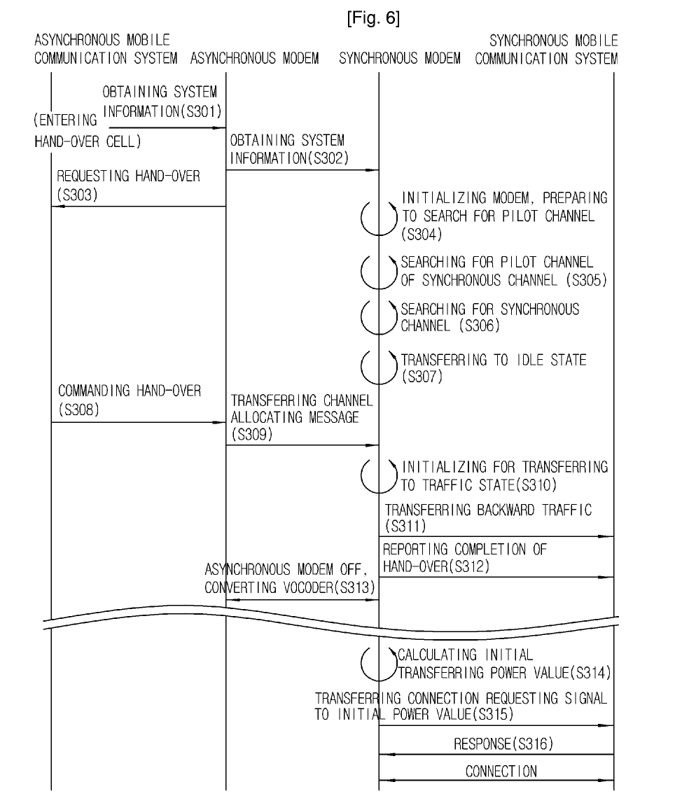

FIG. 6 is a flowchart explaining a method for setting the initial transmitting power of the mobile communication terminal in the synchronous communication network according to the third embodiment of the present invention. As an example, it will be explained that during the service of the asynchronous mobile communication system, the mobile communication terminal can transmit or receives the signal to and from the synchronous mobile communication system.

If the mobile communication system 10 enters the service area of the synchronous mobile communication system from the asynchronous mobile communication system, the asynchronous modem 123 of the mobile communication terminal 10 obtains system information from the base transceiver station of the synchronous hand-over cell area (S301), and recognizes that the mobile communication terminal 10 enters the hand-over cell area. Accordingly, the asynchronous 123 requests the synchronous modem 133 to be operated through the common module 140, while requesting to perform the hand-over to the asynchronous mobile communication system (S303).

Herein, if the synchronous modem 123 of the mobile communication terminal 10 enters the hand-over cell area, it automatically requests to operate the synchronous modem 133, and the signal including system information uses the frequency identical to that used in the asynchronous mobile communication system.

Accordingly, the synchronous modem 133 of the mobile communication terminal 10 is operated and performs the initialization to search for the initialization process of the modem and the pilot channel of the synchronous mobile communication system (S304); searches the pilot channel and the synchronous channel of the synchronous mobile communication system 30 (S305, S306); and transfers to the idle state (S307).

Thereafter, the asynchronous mobile communication system 20 instructs the asynchronous modem 123 to perform the hand-over based on the system information obtained from the asynchronous mobile communication system transmitted in the step S303 (S308), the synchronous modem 123 transmits a channel allocating message to the synchronous modem 133 (S309).

In the steps of S308 and S309, the asynchronous mobile communication system 20 transmits INIT-PWR (the initial power value of the asynchronous communication network, hereinafter referred to as “initial power value” to the asynchronous modem 123, and the asynchronous modem 123 transmits the initial power value transmitted from the synchronous mobile communication system 20 at the time of transmitting the channel allocating message to the synchronous modem 133.

At this time, the initial power value (INIT_PWR) represents the value to which an operator of the network can variably apply according to a specific cell environment.

The size thereof is an average power value outputted from the mobile communication terminal, which is variably determined depending on the cell environment

Accordingly, the synchronous modem 133 performs the initialization for transferring to the traffic state (S310), and transmits a backward traffic to be synchronized with the synchronous mobile communication system 30 (S311).

Then, the synchronous modem 133 reports to the base transceiver station of the synchronous mobile communication system 30 that the hand-over is completed (S312), and then makes the asynchronous modem 123 and the asynchronous vocoder 124 to become off through the common module 140 and operates the synchronous mobile communication system the synchronous vocoder 134 to convert the vocoder (S313).

The mobile communication terminal 10, which completes the hand-over from the asynchronous mobile communication system to the synchronous mobile communication system and is converted to the idle state, is converted to the traffic state according to the user's request, in order to operate an SMS (Short Message Service) transmitted from another mobile communication terminal, or to operate the paging.

The synchronous modem 133 of the mobile communication terminal 10 in the idle state located in the synchronous mobile communication system 30 calculates the initial transmitting power value to be transmitted to the traffic state (S314).

In the step S314, the initial transmitting power value set by the synchronous modem 133 of the mobile communication terminal is calculated as [Formula 1].

Formula 1]

Initial transmitting power value=−(average receiving power of the synchronous modem)+initial power+offset power

Herein, the average receiving power of the synchronous modem represents the average power value transmitted from the base transceiver station and received by the synchronous modem. The high receiving power means that the environment of the synchronous mobile communication system 30, to which the current mobile communication belongs, is good. Thus, at the time of setting the initial transmitting power value of the mobile communication terminal, if the average receiving power value of the synchronous modem 133 is high, the initial transmitting power value is determined to be low, and if the average receiving power value of the synchronous modem 133 is low, the initial transmitting power value is determined to be high.

Also, the initial power value is the value which is transmitted from the asynchronous mobile communication system in the step S309 and transmitted to the synchronous modem by the asynchronous modem. Since the mobile communication terminal 10 is directly transferred to the traffic state without passing the random access step, which determines the initial transmitting power in the idle state, the initial power determined in the asynchronous mobile communication system is reflected to determine the initial transmitting power. Herein, the initial power is the value which is determined in the network based on the average power value outputted from the mobile communication system in a specific cell environment stored by the asynchronous mobile communication system. This cell environment is reflected.

Offset power is the value determined according to the interior characteristic of the mobile communication terminal determining the degree of the signal transmitting and the signal receiving with the network for correcting the value, which varies according to the characteristic of the mobile communication system terminal 10.

The synchronous modem 133 of the mobile communication terminal 10 transmits the connection requesting signal requesting to connect with the synchronous mobile communication system as a calculated initial power value to the synchronous mobile communication system 30(S315).

After the step S315, the synchronous mobile communication system 30 receives the connection requesting signal transmitted as the initial transmitting power from the synchronous modem 133 of the mobile communication terminal 10 and transmitting a response thereto S316, the synchronous mobile communication system 30 and the mobile communication terminal 10 transmits and receives a control message for call setting, etc.

The detailed description explains only the case of the mobile communication terminal capable of transmitting and receiving the signal to and from the synchronous mobile communication system and during the services of the asynchronous mobile communication system.

However, it is possible to apply the mobile communication terminal, which can only receive the signal of the synchronous mobile communication system while using the services of the asynchronous mobile communication system.

Although the invention has been shown and described with respect to a preferred embodiment, it will be understood by those skilled in the art that various changes and modifications may be made without departing from the spirit and scope of the invention as defined in the following claims.

### INDUSTRIAL APPLICABILITY

The present invention relates to a method for hand-over between asynchronous communication network and synchronous communication network of multi mode multi band mobile communication terminal. More particularly, the present invention relates to a method for hand-over between an asynchronous communication network and a synchronous communication network of multi mode multi band for improving the probability of success in the hand-over from the asynchronous communication network and the synchronous communication network of the multi mode multi band mobile communication terminal.

1. A multi mode multi band mobile communication terminal which can communicate with the asynchronous mobile communication system and the synchronous mobile communication system, and which performs hand-over between the asynchronous mobile communication system and the synchronous mobile communication system, comprising:
during communicating with the asynchronous mobile communication system, if conditioned in a predetermined hand-over, an asynchronous modem outputting a modem operating signal for operating a modem to transfer and receive the signal of the synchronous mobile communication system; and
a synchronous modem operated in an off-state according to the modem operating signal outputted from the asynchronous mobile communication system and then transited to a low power mode, which is a standby mode, wherein said multi mode multi band mobile communication terminal performs the hand-over to the multi mode multi band mobile communication terminal according to the hand-over triggering from the asynchronous mobile communication system by the synchronous modem in the standby mode.

2. The multi mode multi band mobile communication terminal according to claim 1, characterized in that if the asynchronous modem transmits or receives signals to and from the asynchronous mobile communication system for setting a call, it determines that the hand-over condition is satisfied.

3. The multi mode multi band mobile communication terminal according to claim 2, characterized in that after operating the modem and performing a hand-over, the synchronous modem transmits and receives signals to and from the synchronous system and maintain the call setting state.

4. The multi mode multi band mobile communication terminal according to claim 1, characterized in that the mobile communication terminal enters the asynchronous mobile communication system area and hand-over cell, which is a boundary area of the synchronous mobile communication system area, the synchronous modem automatically requests to operate the synchronous modem.

5. The multi mode multi band mobile communication terminal according to claim 4, characterized in that after operating the modem and performing the hand-over, the synchronous modem maintains the idle state.

6. The multi mode multi band mobile communication terminal according to claim 1, characterized in that the low power mode of the synchronous modem represents that although the power of the synchronous modem is on, transmitting and receiving of information are suspended and a CPU operation of the modem is stopped.

7. A hand-over method of a multi mode multi band between a synchronous communication network and a synchronous communication network, which can communicate with a asynchronous mobile communication system and a synchronous mobile communication system, and which comprises an asynchronous modem and a synchronous modem in a mobile communication network where a predetermined size of hand-over cell exists between the asynchronous mobile communication system and the synchronous mobile communication system, comprising:
a first step of determining the condition of the hand-over; and
if the hand-over condition is determined in the first step, a second step of operating the synchronous communication network of the mobile communication terminal and transited to a low power mode, which is a standby mode, wherein said the hand-over method performs the hand-over to the synchronous mobile communication system according to the triggering of the hand-over from the asynchronous mobile communication system by the synchronous modem in the standby mode.

8. The hand-over method of a multi mode multi band between na asynchronous communication network and a synchronous communication network according to claim 7, wherein the first step is characterized in that if the asynchronous modem transmits or receives signals to and from the asynchronous mobile communication system for setting a call, it determines that the hand-over condition is satisfied, and requests to the synchronous modem to be operated.

9. The hand-over method of a multi mode multi band between an asynchronous communication network and a synchronous communication network according to claim 8, characterized in that after operating the modem and performing the hand-over, the synchronous modem transmits and receives signals to and from the synchronous system and maintain the call setting state.

10. The hand-over method of a multi mode multi band between a synchronous communication network and a synchronous communication network according to claim 7, wherein the first step is characterized in that if the asynchronous modem enters a hand-over cell, which is a boundary area of a asynchronous mobile communication system area and a synchronous mobile communication system area, the asynchronous modem automatically requests the synchronous modem to be operated.

11. The hand-over method of a multi mode multi band between a synchronous communication network and a synchronous communication network according to claim 11, characterized in that after operating the modem and performing the hand-over, the synchronous modem maintains the idle state.

12. The hand-over method of a multi mode multi band between a synchronous communication network and a synchronous communication network according to claim 11, characterized in that a low power mode of the synchronous modem represents that although the power of the synchronous modem is on, transmitting and receiving of information are suspended and a CPU operation of the modem is stopped.

13. A hand-over method of a multi mode multi band between the synchronous communication network and the synchronous communication network, which can communicate with the asynchronous mobile communication system and the synchronous mobile communication system, and which comprises an asynchronous modem and a synchronous modem in a mobile communication network where a predetermined size of hand-over cell exists between the asynchronous mobile communication system and the synchronous mobile communication system according to the other embodiment of the present invention, comprising the step of, when the mobile communication terminal performs the hand-over from the asynchronous mobile communication system to the synchronous mobile communication system, transferring an initial power value received by the asynchronous modem of the mobile communication system from the asynchronous mobile communication system, wherein the synchronous mobile communication system comprises the steps of:
receiving a connection requesting signal transferred by an initial transmitting power value of the mobile communication terminal calculated based on the initial power value from the mobile communication terminal and transferring a response to the connection requesting signal to the mobile communication terminal; and
transmitting and receiving a traffic between the synchronous mobile communication system and the mobile communication terminal.

14. The hand-over method of a multi mode multi band between the asynchronous communication network and the synchronous communication network according to claim 13, characterized in that:
the initial transmitting power value is calculated by subtracting an average power value of the synchronous modem from the initial electric power;
the average receiving power value of the synchronous modem is calculated by the power value transmitted from the base transceiver station of the synchronous communication mobile system were the synchronous modem locates; and
the initial power value is determined by the average value of the power value outputted from the mobile communication terminal in the asynchronous mobile communication system.

15. The hand-over method of a multi mode multi band between the synchronous communication network and the synchronous communication network according to claim 13, characterized in that:
the initial transmitting power value calculated by the mobile communication terminal is calculated by subtracting the average receiving value of the synchronous modem from the initial power value and further adding an offset power thereto;
the average receiving power value of the synchronous modem is the average value of the power value transmitted from the base transceiver station to be received where the synchronous modem locates, and the initial power value is determined by the average of the power value outputted from the asynchronous mobile communication system to the mobile communication terminal; and
the initial transmitting value is corrected by the offset power.

16. The hand-over method of a multi mode multi band between the asynchronous communication network and the synchronous communication network according to claim 13, characterized in that at the time of the hand-over of the mobile communication terminal, the initial power value is transmitted together with a hand-over requesting message transmitted from the asynchronous mobile communication system to the mobile communication terminal.
